(19) United States
(12) Patent Application Publication
(10) Pub. No.: US 2010/0308290 A1
(43) Pub. Date: Dec. 9, 2010

(54) Multi-Reeve Handling and Hoisting System

(76) Inventor: Martin H. McGuffin, Houston, TX (US)

Correspondence Address: Adams and Reese LLP, 1221 McKinney Street, Suite 4400, Houston, TX, 77010, US

(21) Appl. No.: 12/848,803

(22) Filed: Aug. 2, 2010

Related U.S. Application Data
(63) Continuation of application No. 12/151,933, filed on May 9, 2008, now abandoned.
Application No. 12/151,933 is a continuation-in-part of application No. 12/009,871, filed on Jan. 23, 2008, now abandoned.
Application No. 12/009,871 is a continuation of application No. 11/823,320, filed on Jun. 27, 2007, now abandoned.
(60) Provisional application No. 60/818,080, filed on Jun. 30, 2006.

(51) Int. Cl. B66D 1/26; B66D 1/40; B66D 1/12; B66D 5/32; B66D 1/08; B66D 1/60; B66D 1/36; E21B 41/00

(52) U.S. Cl. 254/286; 254/278; 254/316; 254/314; 254/315

(57) ABSTRACT

An integrated hoisting system includes a base structural component (BSC) assembled on a structural aperture and containing an opening compatible with a structural aperture. The integrated hoisting system further includes a plurality of primary hoisting components affixed to the BSC, wherein each primary hoisting component is disposed in an opposite diagonal corner on said BSC, and further includes a winch drum and at least one lead sheave and a plurality of load path assemblies, each containing a plurality of sheaves. The system further includes a plurality of hoisting lines, a plurality of termination components affixed to said BSC, each termination component including a monitoring unit and a load cell assembly for terminating the hoisting line, and a device configured to control the operation of the integrated hoisting system.

### CROSS REFERENCE TO RELATED APPLICATIONS

The instant application is a continuation of U.S. Non-Provisional application Ser. No. 12/151,933 filed May 9, 2008, still pending, which is a continuation-in-part of U.S. Non-Provisional application Ser. No. 12/009,871 filed Jan. 23, 2008, now abandoned, which is a continuation of U.S. Non-Provisional application Ser. No. 11/823,320 filed Jun. 27, 2007, now abandoned, which claims the benefit of prior U.S. Provisional Application No. 60/818,080, filed Jun. 30, 2006.

### FIELD

The present invention relates generally to the field of wellbore drilling, and in a particular though non-limiting embodiment, to a system for lifting, suspending and lowering blowout preventer assemblies, well control, or applicable heavy equipment.

### BACKGROUND

Blowout Preventer (BOP) Assemblies used in the oil and gas industries have grown exponentially in size and weight. Common BOP weights typically range from 30 to 45 tons in normal applications and are significantly heavier for offshore or special land operations. The industry practice of installing casing/tubing slips, cutting and prepping casing/tubing for wellhead installation or the removal of other well control equipment often requires personnel to work around and under the BOP assembly while it is suspended. The dangerous nature of this process requires equipment systems, methods and practices utilized for the aforementioned purposes to be designed, built, and applied in a manner that ensures that all parties involved are protected and provided with the maximum degree of safety. Many past and present applications used for lifting and handling BOP assemblies often fail to comply with safety standards mandated by regulatory bodies and specified by industry standards. Equipment failures are typically related to wire rope, chains, wire rope slings, holding brakes and other mechanical or structural components. These failures have resulted in serious injuries, fatalities, near-misses, and significant financial losses.

### SUMMARY

Embodiments include an integrated hoisting system that comprises a base structural component (BSC) assembled on a structural aperture, and an opening compatible with a structural aperture. The integrated hoisting system further comprises a plurality of primary hoisting components affixed to the BSC. In one embodiment, each of the primary hoisting components are disposed in an opposite diagonal corner on said BSC, and includes a winch drum and at least one lead sheave and a plurality of load path assemblies, each containing a plurality of sheaves.

The system further comprises a plurality of hoisting lines, a plurality of termination components affixed to said BSC, each termination component including a monitoring unit and a load cell assembly for terminating the hoisting line, and a device configured to control the operation of the integrated hoisting system.

### BRIEF DESCRIPTION OF THE DRAWINGS

The embodiments disclosed herein will be better understood, and numerous objects, features, and advantages made apparent to those skilled in the art by referencing the accompanying drawings.

FIG. 1 is a schematic diagram of components included a multi-reeve handling and hoisting system, according to example embodiments.

FIG. 2 is a cross-sectional view of a two-line, single load path, multi-reeve handling and hoisting system, according to example embodiments.

FIG. 3 is a cross-sectional view of a four-line, single load path, multi-reeving handling and hoisting system, according to example embodiments.

FIG. 4 is a schematic diagram of attachment assembly components supported by a load cell-line termination support component, according to example embodiments.

FIG. 5 is a schematic diagram of an attachment assembly supported by a load cell-line termination support component, according to example embodiments.

FIG. 6 is an overhead view of dual primary hoisting component and dual load cell-line termination support components, according to example embodiments.

FIG. 7 is an overhead view of dual primary hoisting component, dual load cell-line termination support components, and dual multi-reeving crown block assembly components, according to example embodiments

FIG. 8 is a side view of a secondary fail-safe braking system and its placement in the primary hoisting component, according to example embodiments.

FIG. 9 is an overhead view of a secondary fail-safe braking system assembly, according to example embodiments.

FIG. 10 is a schematic diagram of a base structural component, according to example embodiments.

FIG. 11 is an overhead view of a symmetrical piece of a base structural component, according to example embodiments.

FIG. 12 is a bottom view of a symmetrical portion of a base structural component, according to example embodiments.

FIG. 13 is a side view of a multi-reeve crown block assembly, according to example embodiments.

FIG. 14 is a front view of a multi-reeve crown block assembly, according to example embodiments.

FIG. 15 is a rear view of a multi-reeve crown block assembly, according to example embodiments.

FIG. 16 is a multi-directional view of vertical load cell and load path assembly support structures, according to example embodiments.

FIG. 17 is a multi-directional view of vertical load cell and load path assembly support structures, according to example embodiments.

FIG. 18 is an overhead view of vertical load cell and load path assembly support structures, according to example embodiments.

### DESCRIPTION OF EMBODIMENT(S)

The description that follows includes exemplary systems, methods, and techniques that embody techniques of the presently inventive subject matter. However, it is understood that the described embodiments may be practiced without these specific details. In other instances, well-known manufacturing equipment, protocols, structures and techniques have not been shown in detail in order to avoid obfuscation in the description.

Embodiments of the inventive subject matter use a portable or fixed installation hoisting system, designed and built in accordance with the American Petroleum Institute (API) Specification 7K/ISO 14693 and API Recommended Practice (RP) 7L, to safely lift, suspend and lower blowout preventer assemblies or well control and other applicable heavy equipment in the oil and gas industry. Embodiments of the inventive subject matter can be transported and installed for temporary use during land and offshore drilling and completion operations. Furthermore, some embodiments are controlled remotely or manually.

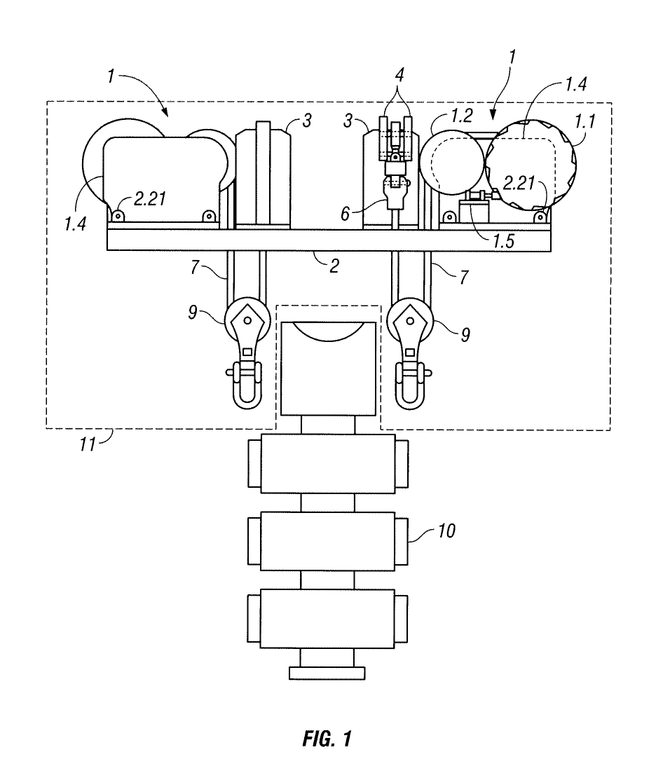

FIG. 1 is a schematic diagram of components included in a multi-reeve handling and hoisting system, according to example embodiments. In FIG. 1, a multi-reeve handling and hoisting system 11 includes dual primary hoisting components 1 and dual load cell-line termination components 3, all of which are disposed in mechanical communication with a base structural component 2.

The primary hoisting components 1 comprise a winch drum assembly 1.1, a guide sheave 1.2, vertical structural support plates 1.4, and a secondary fail-safe braking assembly 1.5. Embodiments of the winch drum assembly 1.1 utilize a variety of power sources. For example, winch drum 1.1 can be hydraulic, electric, or pneumatic. In addition, embodiments of the winch drum can have dimensions that specifically comply with those stated in API Specification 7K/ISO 14693.

The load cell-line termination components 3 include link plates 4 that attach the load cell-line termination component 3 to a load cell assembly 5. A socket 6 terminates a hoisting line 7, and is attached to the load cell assembly 5. The hoisting line 7 reeves a load path assembly 9, which attaches to a blowout preventer assembly 10 by BOP attachment points, slings rigged on the BOP, or other methods that comply with safe, acceptable rigging practices.

Base structural component 2 further comprises a plurality of thru holes 2.21. In this embodiment, the thru holes 2.21 are used to attach the base structural component 2 to the primary hoisting components 1. For example, devises, pins, bolts or other known means of attachment can be used in conjunction with thru holes 2.21 to attach the primary hoisting components 1 on either the inboard or outboard sides of the base structural component 2.

FIG. 1 also illustrates a 4-line system for handling, lifting, moving, etc., BOP assemblies. When the primary hoisting component 1 is installed on the base structural component 2, the hoisting line 7 on the winch drum assembly 1.1 reeves over the guide sheave 1.2 and drops through the rotary table or another structural aperture. The hoisting line 7 is then reeved through a sheave on the load path assembly 9. The sheave on the load path assembly 9 is oriented approximately perpendicular to the guide sheave 1.2 on the primary hoist component 1. After the hoisting line 7 exits the sheave on the load path assembly 9, it travels vertically back through the rotary table or structural aperture. At this point, the hoisting line 7 terminates at socket 6, which is attached to the load cell assembly 5. The load cell assembly 5 is attached to the load cell-line termination component 3 installed on the base structural component. As shown in FIG. 1, this description is identical for the primary hoisting components 1 and load cell-line termination components 3 disposed on either side of the base structural component.

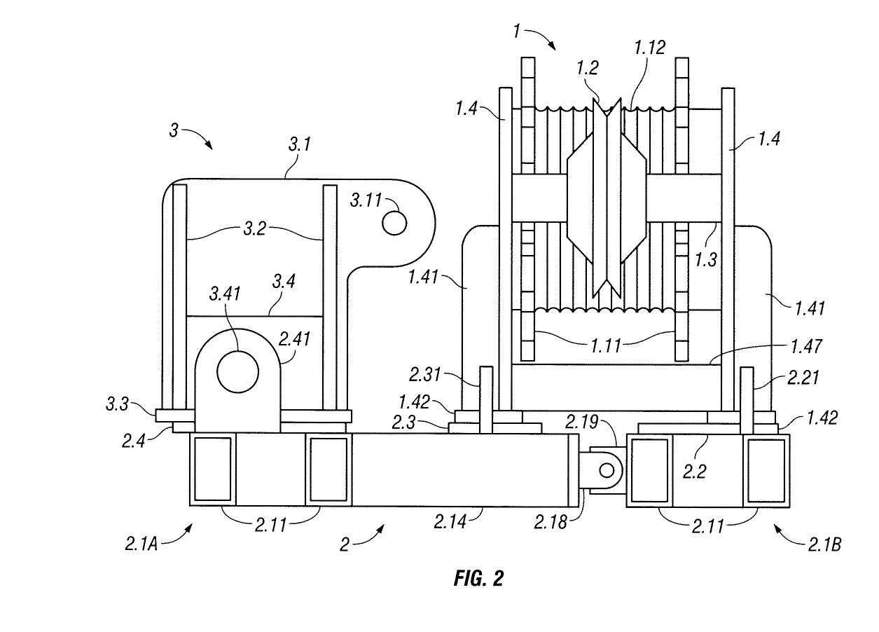

FIG. 2 is a cross-sectional view of a two-line, single load path, multi-reeve handling and hoisting system, according to example embodiments. In FIG. 2, the two-line, single load path, multi-reeve handling and hoisting system includes a primary hoisting component 1, a load cell-line termination component 3, and a base support component 2. The primary hoisting component 1 shown in FIG. 2 comprises a winch assembly 1.1, a guide sheave 1.2, a guide sheave shaft 1.3, vertical structural support plates 1.4, support plate gussets 1.41, lower base support plates 1.42, and an inside lower base lateral support plate 1.47. In some embodiments, winch assembly 1.1 further comprises a grooved winch drum 1.12 and notched winch drum flanges 1.11.

The load cell-line termination component 3 in FIG. 2 includes a master plate 3.1, master support plate gussets 3.2, a base support plate 3.3, and a base reinforcement plate 3.4. In some embodiments, the master plate 3.1 includes thru holes 3.11 provided for terminating a load cell and an end of a hoisting line. Base reinforcement plate 3.4 further comprises a thru hole 3.41 that can be used to attach the load cell-line termination component 3 to the base structural component. Various types of attachment devices can be used with approximately equal efficiency, including pins, devises, bolts and other known means of attachment.

The base support component 2 depicted in FIG. 2 comprises two symmetrical portions 2.1A and 2.1B. Each symmetrical portion 2.1A and 2.1B includes a master longitudinal support beam 2.11, a lateral internal master support beam 2.14, an outside surface support plate 2.2 attached to a fastening member 2.21, an inside surface support plate 2.3 attached to a fastening member 2.31, and a surface support plate 2.4 attached to a fastening member 2.41. In further embodiments, symmetrical portions 2.1A and 2.1B further comprise fastening members 2.18 and 2.19, which fastens them to one another.

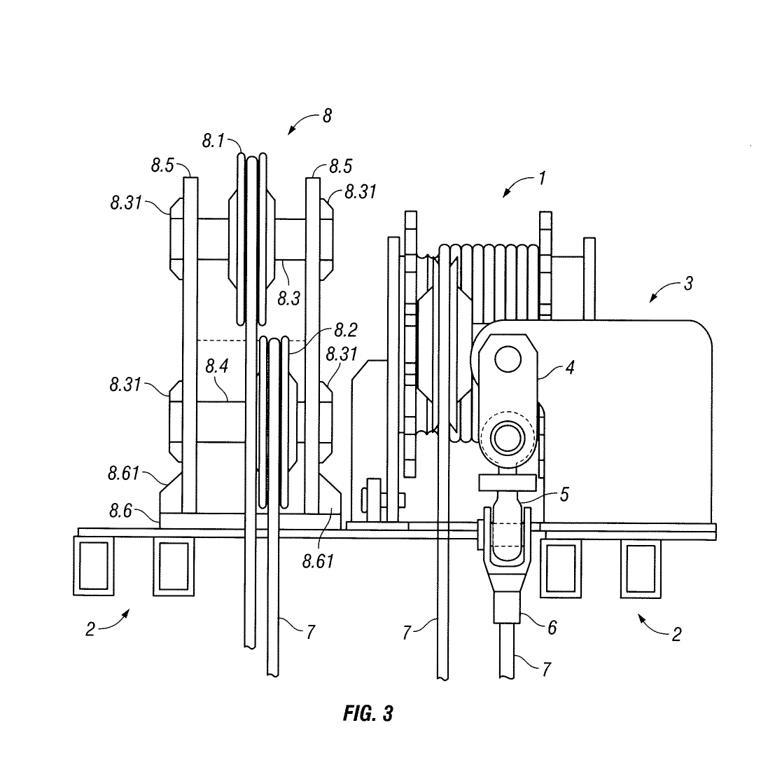

FIG. 3 is a cross-sectional view of a four-line, single load path, multi-reeving handling and hoisting system, according to example embodiments. In FIG. 3, a four-line, single load path, multi-reeving handling and hoisting system includes a multi-reeving crown block assembly 8, the primary hoisting component 1, the load cell-line termination support component 3, and the base support component 2.

The multi-reeving crown block assembly 8 includes an upper sheave 8.1 and a lower sheave 8.2. The upper sheave 8.1 operates on an upper sheave shaft 8.3. The lower sheave 8.2 operates on a lower sheave shaft 8.4. The upper sheave shaft 8.3 and the lower sheave shaft 8.4 are both attached to main structural support plates 8.5. In some embodiments, the upper sheave shaft 8.3 and the lower sheave shaft 8.4 can be reinforced with sheave shaft reinforcement plates. In some embodiments, the multi-reeving crown block assembly 8 further comprises a base structural support plate 8.6 and a plurality of front support gussets 8.61.

In addition to the multi-reeving crown block assembly 8, FIG. 3 depicts the load cell-line termination support component 3. The depicted load cell-line termination support component 3 includes link plates 4, a load cell assembly 5, and a socket 6. As previously mentioned, socket 6 terminates a hoisting line 7, which can be streamed through all of the components included in the multi-reeving handling and hoisting system.

### Load Cell Termination Component(s)

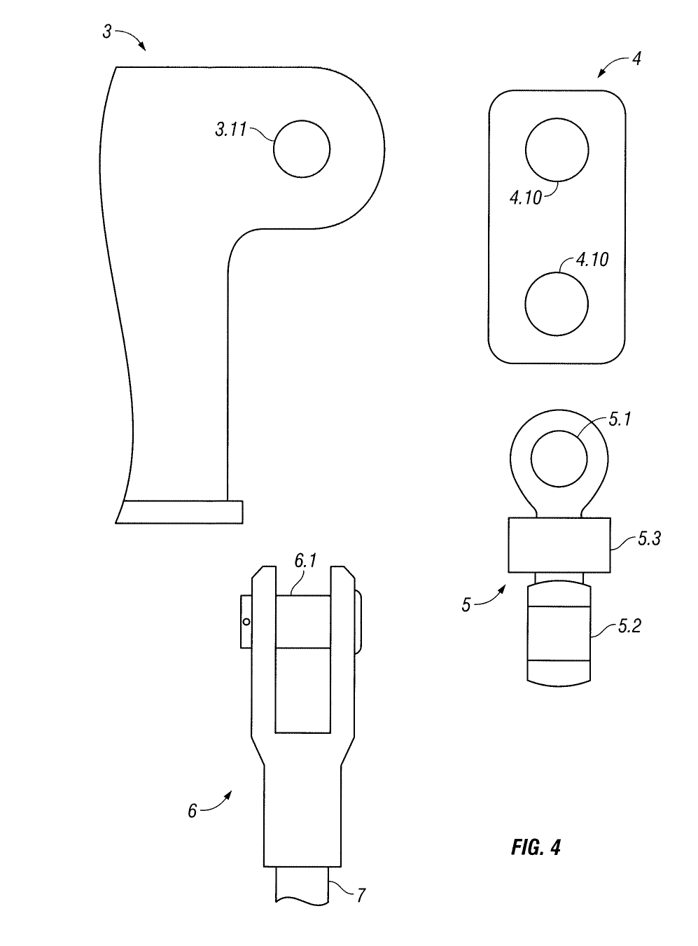

FIG. 4 is a schematic diagram of attachment assembly components that are supported by a load cell-line termination support component, according to example embodiments. FIG. 4 includes load cell-line termination component 3, link plates 4, load cell assembly 5, and socket 6.

Link plates 4 include thru holes 4.10. Load cell assembly 5 includes thru hole 5.1, thru hole 5.2, and load cell 5.3. Socket 6 includes the termination end of hoisting line 7 and thru holes 6.10. In some embodiments, socket 6 can be an open spelter socket, a closed spelter socket, or a part that provides similar functionality. Either of the thru holes 4.10 can be attached to thru hole 3.11, while in some embodiments the remaining thru hole 4.10 is attached to a thru hole 5.1.

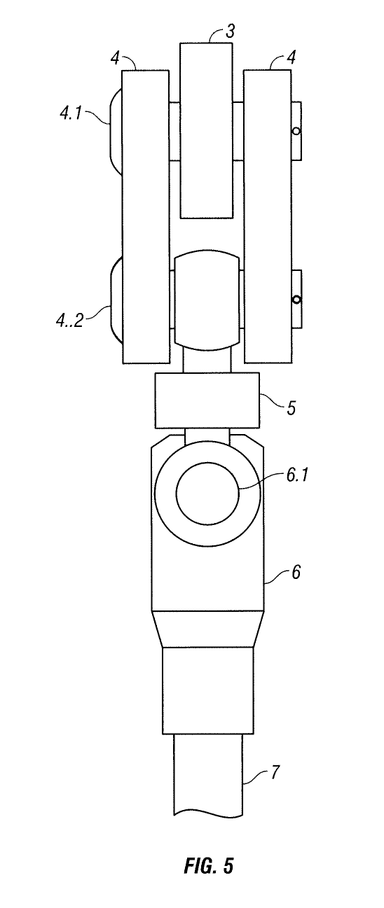

FIG. 5 is a schematic diagram of an attachment assembly supported by a load cell-line termination support component, according to example embodiments. In the embodiment depicted in FIG. 5, the link plates 4, the load cell assembly 5, and the socket are disposed in mechanical communication with one another. FIG. 5 also illustrates that in some embodiments, link plates 4 can attach to load cell-line termination component 3 using link plate pin 4.1. In some embodiments, link plate pin 4.2 attaches link plates 4 to the load cell assembly 5. In the depicted embodiment, a socket pin 6.1 is utilized to attach the load cell assembly 5 to the socket 6.

Embodiments of the load cell termination component can utilize a plurality of master plates 3.1 shown in FIG. 2, which can diminish the need for link plates 4. For example, an embodiment of the load cell termination component using two master plates 3.1 (see FIG. 2) has similar functionality with or without the use of link plates 4. In this embodiment, load cell assembly 5 can be disposed between two master plates 3.1 via thru holes 3.11 and 5.1 (FIG. 4) and attached with removable features such as pins, clevises, bolts or other known means of attachment.

### Primary Hoisting Component(s)

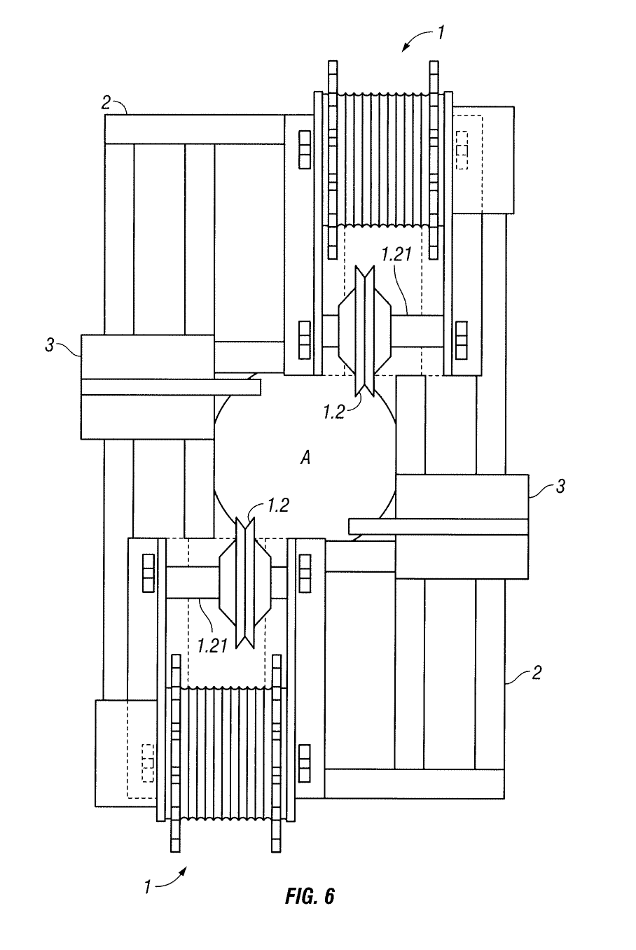

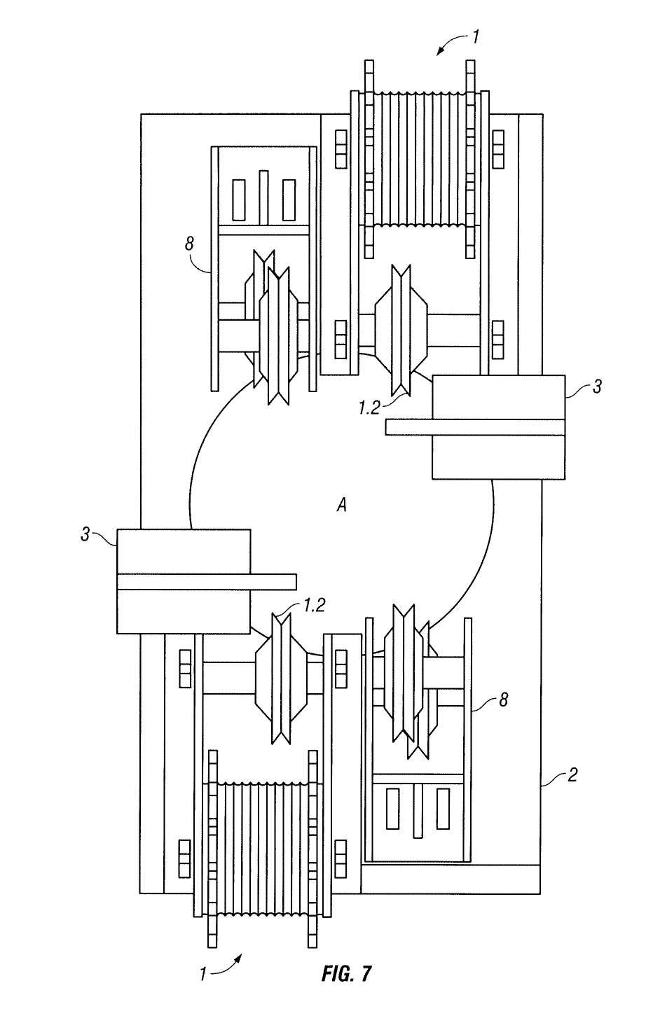

FIG. 6 and FIG. 7 depict various overhead views of dual primary hoisting components 1 and dual load cell-line termination support components 3. FIG. 7 further comprises a plurality of dual multi-reeving crown block assembly components 8. FIGS. 6 and 7 both include the base structural component 2 on which all components can be placed. Furthermore, all components are placed around a rotary aperture A in both figures.

FIGS. 6 and 7 further comprise a plurality of guide sheaves 1.2, which move laterally along sheave shafts 1.21 to allow clearance of the hoisting line, and to avoid structural contact with the rotary aperture A or other structural support. Furthermore, in some embodiments, additional sheaves can be implemented into the primary hoisting component 1 to increase a multi-reeve handling and hoisting system's mechanical advantage. For example, the addition an additional sheave can provide for larger and heavier objects to be handled by a multi-reeve handling and hoisting system.

Although FIGS. 6 and 7 depict dual multi-reeving handling and hoisting system components, additional components can be added for increased support when conducting BOP operations. For example, an embodiment can include four primary hoisting components 1, four load cell-line termination support components 3, and four multi-reeving crown block assembly components 8. In addition, components secured to the base structural component 2 can be positioned in a number of different configurations. For example, the load cell-line termination support components 3 in FIGS. 6 and 7 can effectively be placed opposite their current positions. Certain embodiments include disposition of each primary hoisting component 1 in such a manner that they face each other from opposite diagonal corners and on opposite sides.

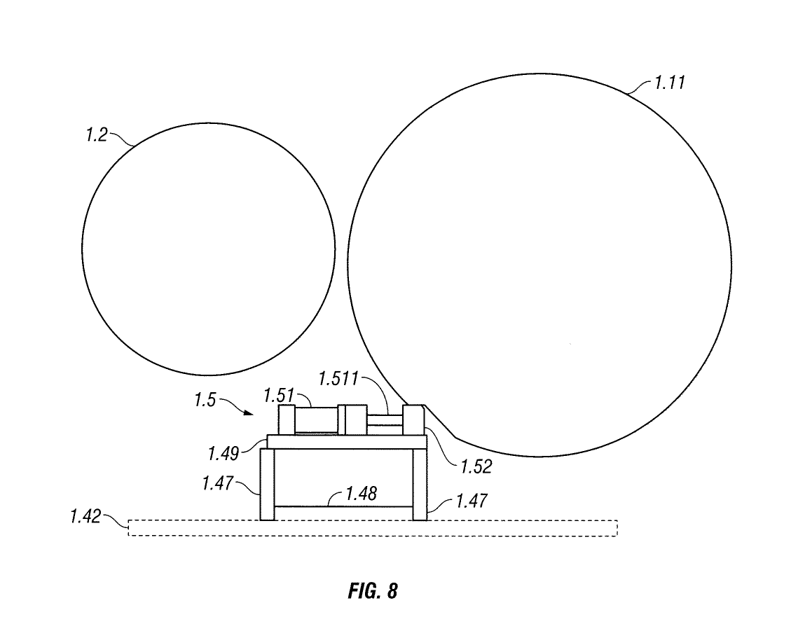

FIG. 8 is a side view of a secondary fail-safe braking system and its placement in the primary hoisting component, according to example embodiments. FIG. 8 includes a notched winch drum flange 1.11, the guide sheave 1.2, and a secondary fail-safe braking assembly 1.5.

The secondary fail-safe braking assembly 1.5 further comprises a mechanical control mechanism 1.51, a mechanical control mechanism piston rod 1.511, a drum flange engagement bar 1.52, inside lower base lateral support plates 1.47, the lower base support plates 1.42, and lower base longitudinal support plates 1.48. The secondary fail-safe braking assembly 1.5 is placed on a surface support plate 1.49.

As illustrated in FIG. 8, the secondary fail-safe braking system can be utilized to stop the winch drum operation, thereby halting the operation of the multi-reeve handling and hoisting system. In some embodiments, the system is spring applied and disengages from the drum when power is supplied to rotate the drum in either direction. For example, when power is not applied, lost, or in a neutral state, the mechanical control mechanism 1.51 protracts the mechanical control mechanism piston rod 1.511 and pushes the attached drum flange engagement bar 1.52 toward a drum flange notch 1.115, thereby prohibiting handling system operations. The mechanical control mechanism 1.51 can include any suitable mechanical device for moving or controlling a mechanism or system, such as an electrical, mechanical, hydraulic, or pneumatic actuator. Furthermore, the mechanical control mechanism 1.51 can be activated by a switch, toggle, remote, push-button or any type of mechanical linkage or change in automation.

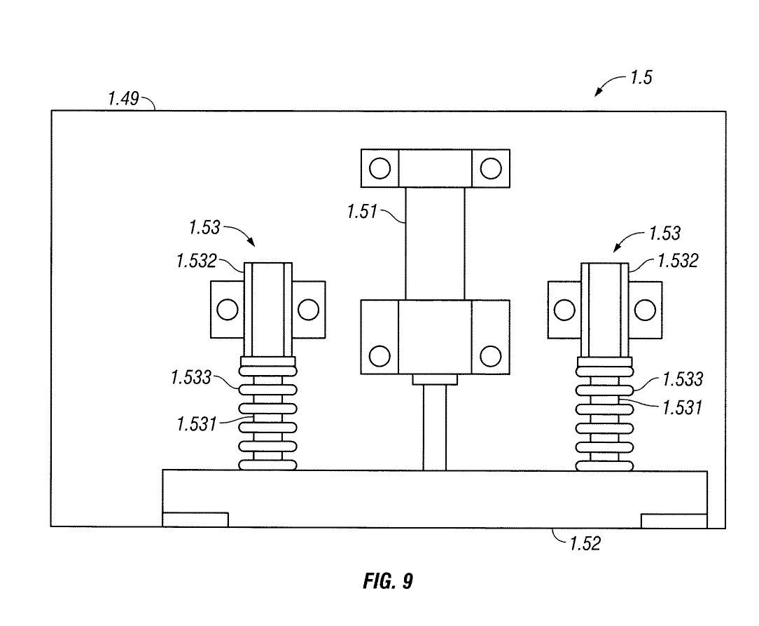

FIG. 9 is an overhead view of a secondary fail-safe braking system assembly, according to example embodiments. In FIG. 9, the secondary fail-safe braking system 1.5 includes the mechanical control mechanism 1.51, the drum flange engagement bar 1.52, the mechanical control mechanism piston rod 1.511, and guide rod assemblies 1.53. The guide rod assemblies 1.53 each include a guide rod 1.531, a guide rod tube 1.532, and engagement springs 1.533. Furthermore, attachments 1.52 join the mechanical control mechanism 1.51 to surface support plate 1.49.

In some embodiments, prior to activation, the drum flange engagement bar 1.52 is positioned near the mechanical control mechanism 1.51 and the guide rods 1.531 are pushed into the guide rod tubes 1.532, thus constricting the engagement springs 1.533. During functionality of the secondary fail-safe braking system 1.5, the drum flange engagement bar 1.52 receives force from the extension of the guide rods 1.531 and the protracting engagement springs 1.533, in addition to thrust of the mechanical control mechanism piston rod 1.511, according to some embodiments.

### Base Structural Component

The multi-reeve handling and hoisting system includes a base structural component (“BSC”) that can be assembled on the rig floor rotary table, structural beams, structural surfaces, etc. that allow for safe and sufficient support for the integrated hoisting system. In some embodiments, the BSC is designed to assemble on a structure with an aperture that is dimensionally compatible with the opening of the BSC. The opening of the BSC can be circular, rectangular, etc., or any shape that allows a hoisting line and another applicable equipment to be disposed with an aperture. The BSC includes two or more structurally symmetrical components that pin together at certain points, allowing it to become one integral structure. Furthermore, optional affixed or removable/adjustable structural components for allowing multi-line reeving, end termination, load-cell installation and resultant load support can be attached to the BSC. Embodiments of the BSC also allow two or more hoisting components to be affixed. The hoisting components can be either permanently affixed, or alternatively, attached with removable features such as pins, devises, bolts or other known means of attachment. The hoisting line and other necessary equipment reeved through the components that are attached or affixed to the BSC should fit properly within the opening of the BSC and align symmetrically with the structure aperture on which the BSC is assembled.

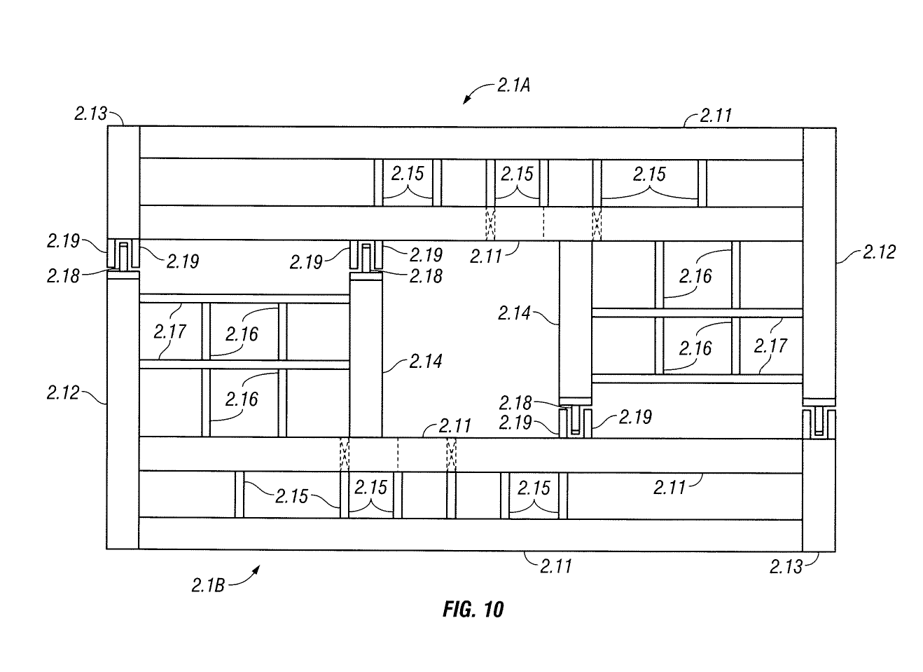

FIG. 10 is a schematic diagram of a base structural component, according to example embodiments. As illustrated in FIG. 10, the base structural component 2 includes a symmetrical piece 2.1A and a symmetrical piece 2.1B. Both symmetrical portions 2.1A and 2.1B include master longitudinal support beams 2.11, long lateral external master support beams 2.12, short lateral external master support beams 2.13, lateral internal master support beams 2.14, interim support plates 2.15, lateral interim support plates 2.16, and longitudinal interim support plates 2.17. Symmetrical pieces 2.1A and 2.1B also include fastening members 2.18 and 2.19 that attach them to one another. In some embodiments, the symmetrical pieces 2.1A and 2.1B are assembled such that the center opening is disposed directly above the aperture of the structure on which the BSC is assembled.

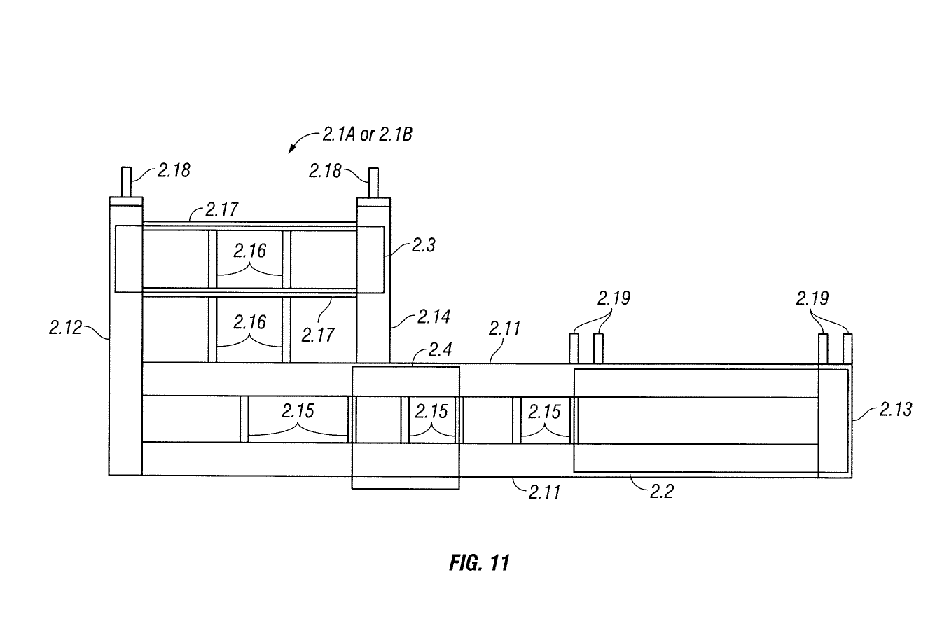

FIG. 11 is an overhead view of a symmetrical piece of a base structural component, according to example embodiments. The embodiment of FIG. 11 comprises either of symmetrical portions 2.1A or 2.1B, and otherwise includes all of the same components mentioned in FIG. 10. In addition, FIG. 11 includes an outside surface support plate 2.2, an inside surface support plate 2.3, and a surface support plate 2.4. In some embodiments, these plates can be used to attach and support other components. For example, a primary hoisting component can be attached atop the outside surface support plate 2.2, while the surface support plate 2.4 can be used to for the placement of a load cell-line termination component.

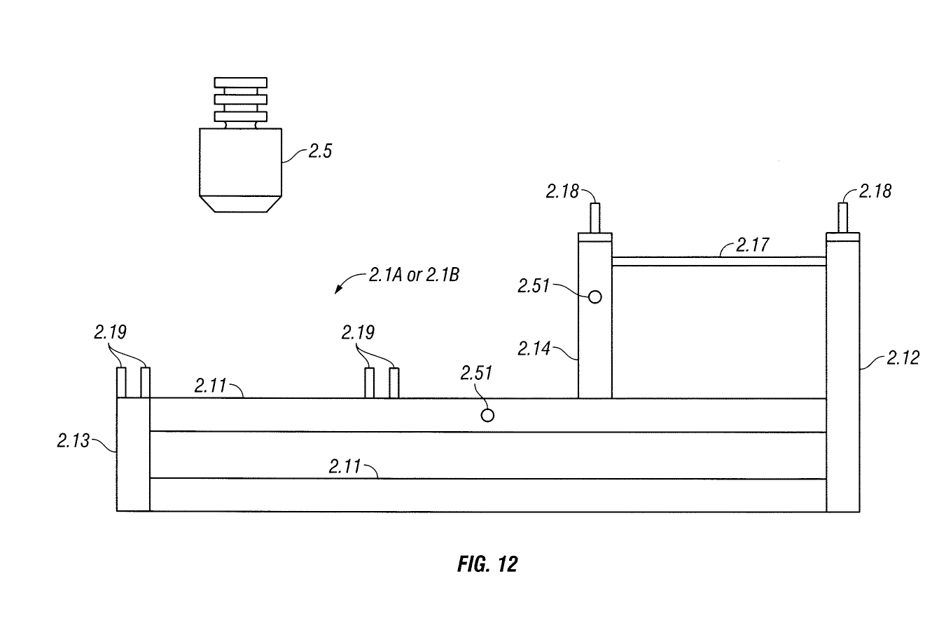

FIG. 12 depicts a bottom view of a symmetrical portion of a base structural component according to certain example embodiments. FIG. 12 can depict either of symmetrical portions 2.1A or 2.1B, and further comprises master longitudinal support beams 2.11, long lateral external master support beam 2.12, short lateral external master support beam 2.13, lateral internal master support beam 2.14, longitudinal interim support plate 2.17, and fastening members 2.18 and 2.19. In addition, FIG. 12 includes alignment pin receptacles 2.51. Embodiments can use alignment pins 2.5 attached to alignment pin receptacles 2.51 for securing and aligning the base structural component with a structure such as a rotary aperture.

### Multi-Reeving Crown Block Assembly

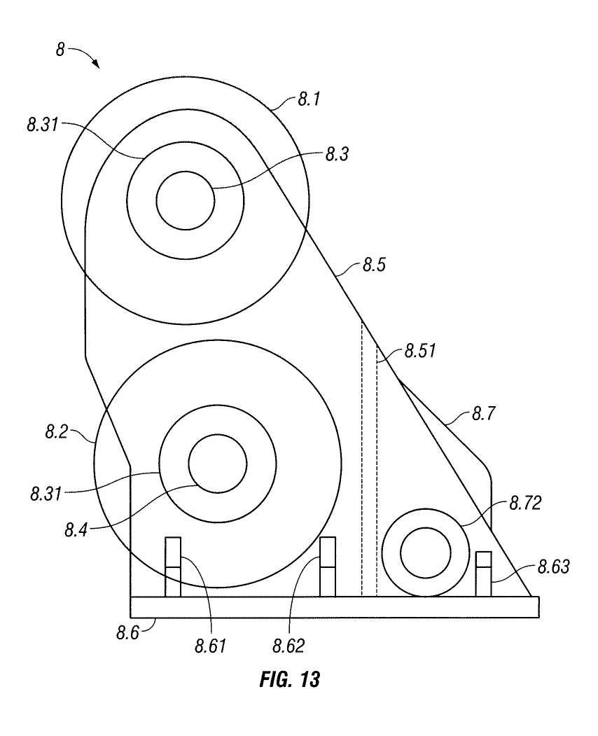

FIG. 13 is a side view of a multi-reeve crown block assembly, according to example embodiments. In FIG. 13, the multi-reeving crown block assembly 8 includes an upper sheave 8.1 and a lower sheave 8.2. The upper sheave 8.1 operates on the upper sheave shaft 8.3, with the lower sheave 8.2 in turn operating on the lower sheave shaft 8.4. In the depicted embodiment, the upper sheave shaft 8.3 and the lower sheave shaft 8.4 are both attached to the main structural support plates 8.5. The upper sheave shaft 8.3 and the lower sheave shaft 8.4 can be reinforced with sheave shaft reinforcement plates 8.31 in some embodiments. The multi-reeving crown block assembly 8 also includes vertical support and rear lateral reinforcement plates 8.51, the base structural support plate 8.6, front support gussets 8.61, middle support gussets 8.62, and rear support gussets 8.63.

As shown, the multi-reeving crown block assembly 8 shown in FIG. 13 further comprises a rear structural plate 8.7. Both the rear structural plate 8.7 and the main structural plate 8.5 include thru holes 8.72. Thru holes 8.72 are used to attach the vertical support and rear lateral reinforcement plates 8.51 to both the rear structural plate 8.7 and the main structural plate 8.5. For example, an anchor pin, thru hole bar, or some type of thru hole attachment device can be placed through thru holes 8.72 to attach the rear structural plate 8.7 to the vertical support and rear lateral reinforcement plates 8.51.

In some embodiments, the upper sheave 8.1 and lower sheave 8.2 are aligned to move on a similar vertical plane, and are designed for lateral movements along the shaft for uniform wire line alignment. The sheaves 8.1 and 8.2 are positioned parallel with the primary hoisting components' lead sheaves. Furthermore, in some embodiments, the upper sheave 8.1 is offset above the lower sheave 8.2 (as illustrated in FIG. 7).

The multi-reeving crown block assembly 8 can be utilized with a two sheave load path 9 and allows for reeving additional parts of hoisting lines in some embodiments. Additional sheaves can increase a multi-reeve handling and hoisting system's mechanical advantage. For example, the addition of upper sheave 8.1 and lower sheave 8.2 can allow four part line reeving in each load path, giving the system a combined eight line mechanical advantage. Furthermore, this mechanical advantage can provide for larger and heavier objects to be handled, lifted, moved, etc., with enhanced balance and precision. For example, above average weighted blowout preventers can be safely handled with the addition of multi reeving crown block assemblies 8 to the multi-reeve handling and hoisting system.

As in the 4-line system, the hoisting line 7 streams from the winch drum assembly 1.1 to the guide sheave 1.2 (guide sheave 1.2 has lateral movement capability to align with the hoisting line 7 being spooled on the winch drum assembly 1.1.) The hoisting line 7 then crosses and drops downwardly over the guide sheave 1.2 through a structural aperture to the load path assembly 9. The hoisting line 7 enters the outside sheave of the load path assembly 9 on the hoist mechanism side and exits vertically on the multi-reeving crown block assembly 8 side of this sheave. The end of the hoisting line 7 then passes through the structural aperture, enters the front side the lower sheave 8.2 on the crown block assembly, passes the top of the lower sheave 8.2, and then reeves over the back and top of the upper sheave 8.1. The upper sheave 8.1 shall be positioned such that the hoisting line 7 aligns properly with the inside sheave of the load path assembly 9. The hoisting line 7 passes as described over the upper sheave 8.1 and then downward through the structural aperture to the inside sheave of the load path assembly 9. The line will pass over the inside sheave and again travel vertically through the structural aperture to the load cell-line termination component 3 located on the primary hoisting component 1 side of the BSC. In some embodiments, the system will be hydraulic and will have remote control capacity.

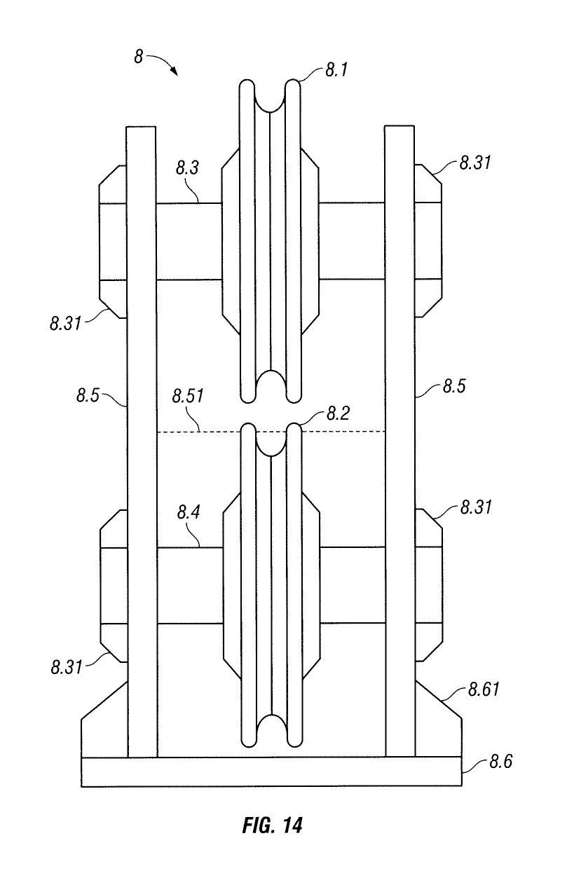

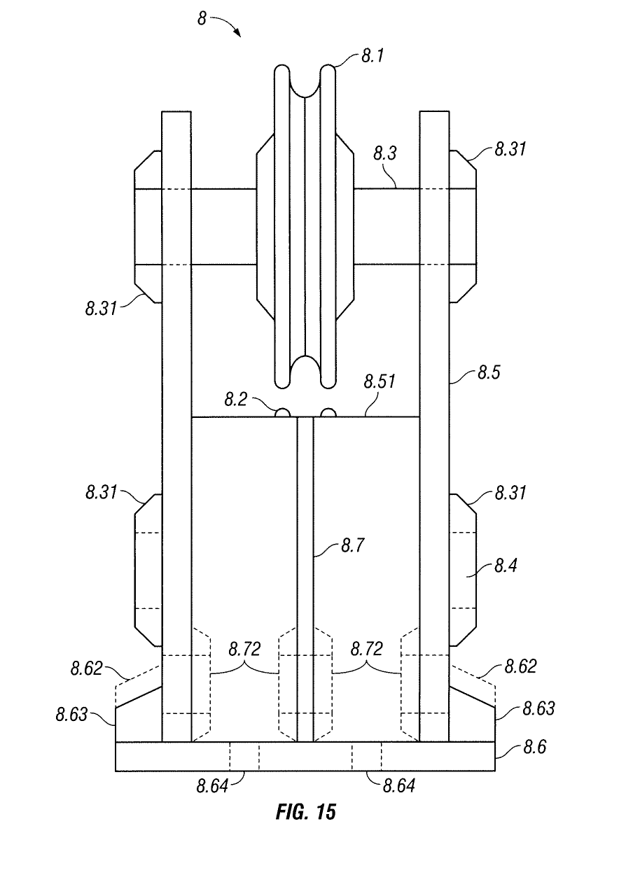

FIG. 14 and FIG. 15 are front and rear views, respectively, of a multi-reeve crown block assembly, according to example embodiments. In FIG. 14 and FIG. 15, the multi-reeving crown block assembly 8 includes the upper sheave 8.1 and the lower sheave 8.2. The upper sheave 8.1 operates on the upper sheave shaft 8.3. The lower sheave 8.2 operates on the lower sheave shaft 8.4. The upper sheave shaft 8.3 and the lower sheave shaft 8.4 are both attached to the main structural support plates 8.5. The upper sheave shaft 8.3 and the lower sheave shaft 8.4 can be reinforced with sheave shaft reinforcement plates 8.31 in some embodiments. The multi-reeving crown block assembly 8 also includes vertical support and rear lateral reinforcement plates 8.51 and the base structural support plate 8.6. FIG. 14 also depicts front support gussets 8.61. Additionally, FIG. 15 illustrates middle support gussets 8.62, rear support gussets 8.63, rear structural plate 8.7, and thru holes 8.72.

Although FIG. 14 illustrates two sheaves, the multi-reeving crown block assembly 8 can include additional sheaves for increased reeving functionality and overall mechanical advantage. For example, in some embodiments, two or more upper sheaves 8.1 can operate on upper sheave shaft 8.3, while two or more lower sheaves 8.2 can operate on lower sheave shaft 8.4.

FIG. 15 provides an improved view of how the rear lateral reinforcement plates 8.51 are attached to the rear structural plate 8.7 and the main structural plate 8.5. In addition, FIG. 15 includes slots 8.64 in base structural support plate 8.6. Slots 8.64 can be used to attach the multi-reeving crown block assembly 8 to the base structural component. For example, in some embodiments, a clevis pin, set screw, etc., can be utilized through slots 8.64 to join the multi-reeving crown block assembly 8 to the base structural component.

### Vertical Load Cell and Load Block Assembly Support Structures

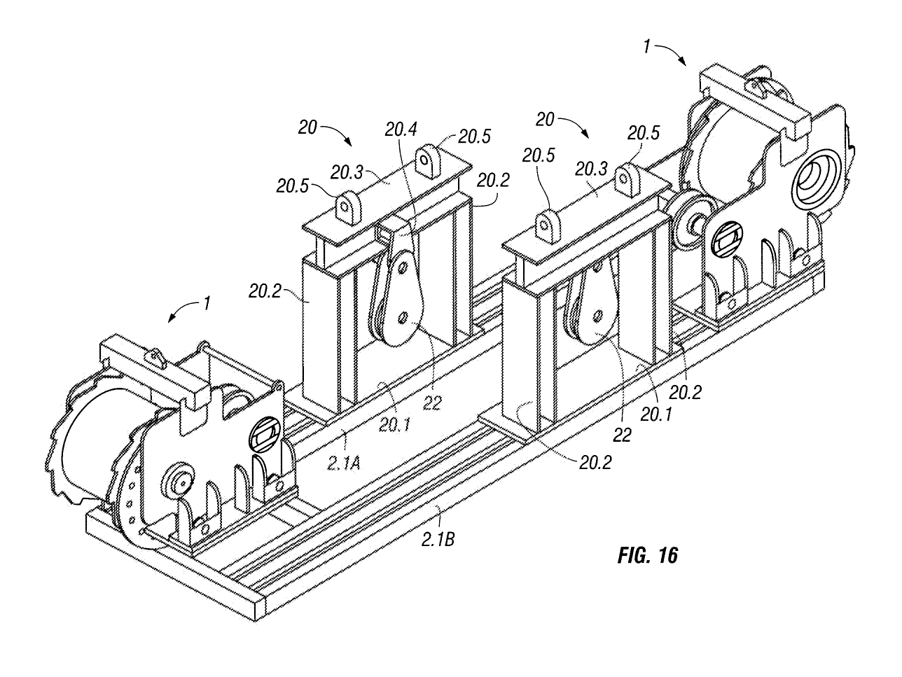

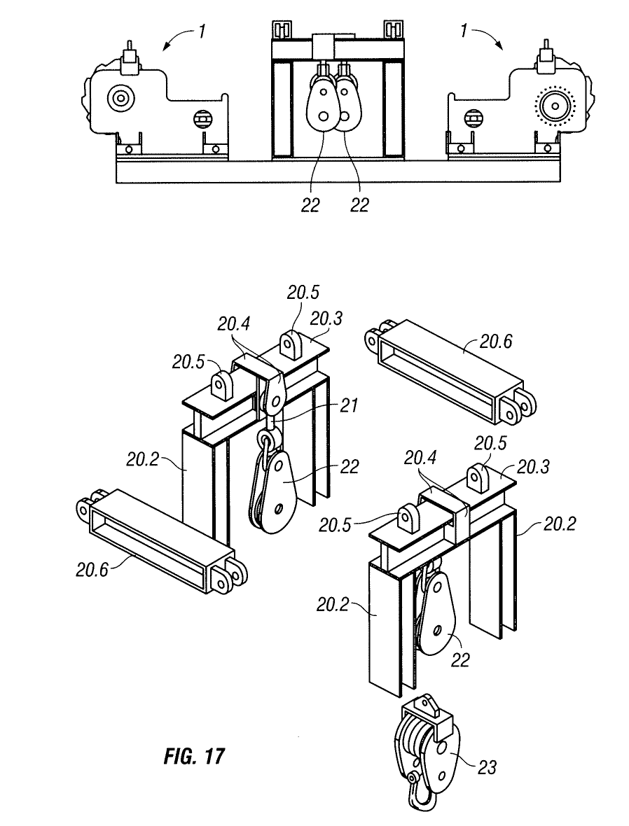

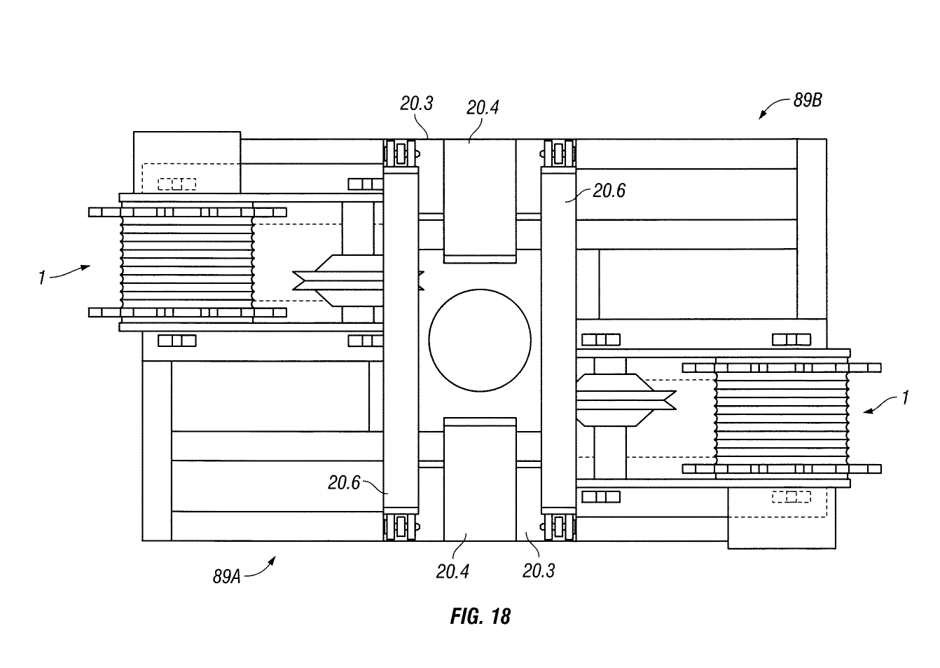

FIG. 16, FIG. 17, and FIG. 18 depict embodiments of the multi-reeve hoisting and handling system using vertical load cell and load path assembly support structures in permissive mechanical disposal with primary hoisting components. In FIG. 16, the multi-reeve hoisting and handling system comprises base structural components 2.1A and 2.1B and dual vertical load cell and load path assembly support structures 20 functioning in conjunction with dual primary hoisting components 1.

Each vertical load cell and load path assembly support structure 20 further comprises a lower support plate 20.1, vertical support beams 20.2, a top support beam 20.3, a load cell and load path assembly support beam 20.4, and fastening members 20.5. Additionally, a load cell assembly 21 (see FIG. 17) attached to a load block assembly 22 is supported by the load cell and load path assembly support beam 20.4. In some embodiments, the load cell and load path assembly support beam 20.4 allows the load block assembly 22 to be vertically aligned above the aperture, rotary table, etc., on which the base structural component is assembled so as to permit a hoisting line 7 to pass seamlessly through the base structural component and aperture, rotary table, etc., opening. The load block assembly 22 can have a plurality of sheaves to allow for more hoisting strength and efficiency. The load cell and load path assembly support beam 20.4 can traverse along the top support beam 20.3 or remain in a fixed position, according to some embodiments. Furthermore, in some embodiments, the load cell assembly 21 can possess unconstrained movement traits or remain in a fixed position.

As previously mentioned, the base structural component includes two or more structurally symmetrical components that pin together at certain points, allowing it to become one integral structure. FIG. 16 depicts a symmetrical piece 2.1A and a symmetrical piece 2.1B, each of which has the ability to independently support and attach to a vertical load cell and load path assembly support structure 20, according to some embodiments.

In addition to the components in FIG. 16, FIG. 17 depicts dual vertical load cell and load path assembly support structures 20 further comprising cross beams 20.6 and load path assemblies 23. FIG. 17 also illustrates a side view of the dual vertical load cell and load path assembly support structures 20. In some embodiments, the cross beams 20.6 can provide structural support of the vertical load cell and load path assembly support structures 20. Furthermore, additional load path assembly support beams 20.4 (comprising load block assemblies 22 suspended from load cell assemblies 21) can be attached to the cross beams 20.6 to allow for greater hoisting and handling functionality. For example, an embodiment with additional load block assemblies 22 suspended from load cell assemblies 21 can allow for a 12-line hoisting and handling system, resulting in increased functional precision and overall safety. In FIG. 18, an overhead view of the dual vertical load cell and load path assembly support structures 20 is depicted to illustrate how they can be disposed with the base structural component and aligned with the primary hoisting components 1.

During functionality, the load block assembly 22 attached to the vertical load cell and load path assembly support structure 20 is in constant mechanical disposal with a primary hoisting component 1. A hoisting line 7 can be reeved over a primary hoisting component's guide sheave 1.2 and then downward through the rotary table or structural aperture and reeve through a sheave of the load path assembly 23. The hoisting line 7 then exits the sheave of the load path assembly 23 and travels back up to a sheave attached to the load block assembly 22. The hoisting line will then exit the sheave attached to the load block assembly 22 and again travel downward to the load path assembly where it can be terminated at the load path assembly's 23 termination member 23.1.

While the embodiments are described with reference to various implementations and exploitations, it will be understood that these embodiments are illustrative and that the scope of the invention(s) is not limited to them. In general, techniques for an integrated hoisting system as described herein may be implemented with facilities consistent with any structural or mechanical system(s). Many variations, modifications, additions, and improvements are possible.

Plural instances may be provided for components, operations or structures described herein as a single instance. Finally, boundaries between various components, operations and functionality are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An integrated hoisting apparatus comprising:
a plurality of primary hoisting components, each of which is configured to simultaneously reeve a hoisting line through a load path assembly, said load path assembly comprising a plurality of sheaves, wherein said hoisting line is ascended through an associated structural aperture;
a plurality of termination components, each of which is configured to support a weight of the load path assembly;
a base structural component configured to support each primary hoisting assembly and each termination component and further comprising an opening through which said hoisting lines are passed; and
a controller for controlling operation of the integrated hoisting system.

2. The integrated hoisting apparatus of claim 1, wherein each primary hoisting component further comprises:
a winch assembly for winding and unwinding said hoisting line, wherein said winch assembly further comprises a winch drum and a plurality of notched drum flanges.

3. The integrated hoisting apparatus of claim 1, wherein each primary hoisting component further comprises:
an anti-rotational device disposed in permissive mechanical communication with said notched drum flanges, which when said anti-rotational device is engaged with said notched drum flanges will prohibit operation of the primary hoisting component.

4. The integrated hoisting apparatus of claim 1, wherein each primary hoisting component further comprises:
a lead sheave configured to guide said hoisting line, wherein said sheave is attached to a shaft and is further disposed in mechanical communication with said hoisting line.

5. The integrated hoisting apparatus of claim 1, wherein each primary hoisting component further comprises:
a controlled lowering mechanism.

6. The integrated hoisting apparatus of claim 1, wherein each of said termination components further comprises:
a monitoring system, wherein said monitoring system is configured to detect the weight and balance of the load path assembly.

7. The integrated hoisting apparatus of claim 1, wherein each of said termination components further comprises:
one or more support plates, wherein said support plates are configured to attach to a load cell assembly, wherein said load cell assembly is configured to terminate said hoisting line.

8. The integrated hoisting apparatus of claim 1, wherein said base structural component further comprises:
a plurality of discrete sections, wherein each section is configured for assembly on opposing sides of an aperture.

9. The integrated hoisting apparatus of claim 1, wherein said base structural component further comprises:
a plurality of support plates, wherein each support plate further comprises a plurality of fastening members used to fasten said primary hoisting components and said termination components to said base structural component.

10. The integrated hoisting apparatus of claim 1, further comprising a power source, wherein said power source consists of at least one operating source selected from the group consisting of hydraulic, electric and pneumatic.

11. An integrated hoisting apparatus comprising:
a plurality of primary hoisting components, each of which is configured to simultaneously reeve a hoisting line through a load path assembly containing a plurality of sheaves, wherein said hoisting line is ascended through a structural aperture;
a plurality of termination components, each of which is configured to support a weight of the load path assembly;
a plurality of secondary hoisting components, each of which is configured to simultaneously reeve additional hoisting lines through a load path assembly;
a base structural component configured to support each primary hoisting component, each termination component, and each secondary hoisting component; and
a device configured to control the operation of the integrated hoisting apparatus.

12. The integrated hoisting apparatus of claim 11, wherein each secondary hoisting component further comprises:
a plurality of sheaves, each of which is configured to guide additional hoisting lines, wherein each sheave is attached to a shaft and moves in coordination with the hoisting line.

13. The integrated hoisting apparatus of claim 11, wherein said base structural component further comprises:
a plurality of support plates, wherein each of said support plates includes a fastening component for fastening the primary hoisting components to the termination components and the secondary hoisting components.

14. A multi-reeve integrated hoisting system comprising:
a base structural component assembled on a structural aperture and containing an opening compatible with a structural aperture;
a plurality of primary hoisting components affixed to the base structural component, wherein each primary hoisting component is disposed in an opposite diagonal corner on said base structural component and includes a winch drum and at least one lead sheave;
a plurality of load path assemblies, each containing a plurality of sheaves;
a plurality of hoisting lines;
a plurality of termination components affixed to said base structural component, each termination component including a monitoring unit and a load cell assembly for terminating the hoisting line; and
a device configured to control the operation of the integrated hoisting system.

15. The multi-reeve integrated hoisting system of claim 14 further comprising:
a plurality of secondary hoisting components affixed to said base structural component, wherein each of said secondary hoisting components is disposed in mechanical communication with each of said primary hoisting components and includes a plurality of secondary sheaves.

16. The multi-reeve integrated hoisting system of claim 14, wherein each of said hoisting lines are spooled on each of said winch drums of each of said primary hoisting components and unspooled downward over a lead sheave of each of said primary hoisting components so that they pass through said aperture.

17. The multi-reeve integrated hoisting system of claim 14, wherein each of said hoisting lines are reeved through a first sheave connected to a load path assembly.

18. The multi-reeve integrated hoisting system of claim 14, wherein each of said hoisting lines travel upward through the structural aperture to each of said load cell assemblies attached to each of said termination components.

19. The multi-reeve integrated hoisting system of claim 15, wherein each of said hoisting lines are reeved upward from each of said load path assemblies through a primary sheave affixed to each of said secondary hoisting components.

20. The multi-reeve integrated hoisting system of claim 15, wherein each of said hoisting lines are unspooled downward over a secondary sheave of each of said secondary hoisting components, through said structural aperture, and then reeved through a second sheave connected to each of said load path assemblies.

21. The multi-reeve integrated hoisting system of claim 15, wherein each of said hoisting lines travel upward through the structural aperture to each of said load cell assemblies attached to each of said termination components.

22. An integrated hoisting apparatus comprising:
a plurality of primary hoisting components, each of which is configured to simultaneously reeve a hoisting line through a load block assembly containing a plurality of sheaves, wherein said hoisting line is ascended through a structural aperture and reeved through a load path assembly containing a plurality of sheaves;
a plurality of hoisting support structures, each of which is configured to support a load cell assembly, said load block assembly, and said load path assembly;
a base structural component configured to support each primary hoisting component and each hoisting support structure; and
a device configured to control the operation of the integrated hoisting apparatus.

23. The integrated hoisting apparatus of claim 22, wherein each hoisting support structure further comprises:
a plurality of primary support beams, each of which is configured to support a weight of said load block assembly, wherein each of said primary support beams are multi-directionally positioned.

24. The integrated hoisting apparatus of claim 23 further comprising:
a plurality of secondary support beams, each of which is configured to support a weight of said load block assembly and said load path assembly, wherein said load block assembly is affixed to said load cell assembly, wherein said load cell assembly is affixed to each of said secondary support beams.
